(19) United States
(12) Patent Application Publication
(10) Pub. No.: US 2024/0284072 A1
(43) Pub. Date: Aug. 22, 2024

(54) IMAGING ELEMENT AND RANGING DEVICE

(71) Applicant: Panasonic Intellectual Property Management Co., Ltd., Osaka (JP)

(72) Inventor: Yutaka HIROSE, KYOTO FU (JP)

(21) Appl. No.: 18/650,988

(22) Filed: Apr. 30, 2024

Related U.S. Application Data
(63) Continuation of application No. PCT/JP2022/040046, filed on Oct. 27, 2022.

(30) Foreign Application Priority Data
Nov. 2, 2021 (JP) 2021-179342

(51) Int. Cl. H04N 25/773; G01S 7/4863

(52) U.S. Cl. CPC H04N 25/773; G01S 7/4863

(57) ABSTRACT

An imaging element includes a light source and a plurality of pixels. Each of the plurality of pixels includes: a light-receiving element; a first capacitor, and a charge emitter provided in each of the plurality of pixels, the charge emitter being configured to emit a charge to the first capacitor for a certain period of time ΔT when the light-receiving element detects light emitted from the light source and reflected by a subject.

### CROSS-REFERENCE OF RELATED APPLICATIONS

This application is a Continuation of International Patent Application No. PCT/JP2022/040046, filed on Oct. 27, 2022, which in turn claims the benefit of Japanese Patent Application No. 2021-179342, filed on Nov. 2, 2021, the entire disclosures of which Applications are incorporated by reference herein.

### TECHNICAL FIELD

The present disclosure relates to an imaging element and a distance measurement device.

### BACKGROUND ART

There are distance measurement devices and systems which use light-receiving arrays including a plurality of single-photon avalanche diodes (SPADs) to measure a distance to a subject.

For example, Patent Document 1 discloses a distance measurement device that includes a controller and a distance calculator. The controller determines a distance range for which the distance measurement is to be performed, and divides a time range corresponding to this distance range into a plurality of sections. The controller controls the distance measurement device so that pulse light is emitted at each time range to expose a light receiving unit. The distance calculator then calculates a distance to a subject according to the results of exposure of the light receiving unit. The accuracy of the distance measurement at this time is determined by the pulse width of the pulse light emitted by a light emitting unit.

### CITATION LIST

### Patent Document

Patent Document 1: Japanese Patent No. 6910010

### SUMMARY OF THE INVENTION

### Technical Problem

The distance measurement device as disclosed in Patent Document 1 may include a light receiving unit that performs photon counting, in which a subject is irradiated with pulse light multiple times in one exposure period, thereby counting light (photons) reflected by the subject. Such a light receiving unit has a capacitor in a pixel, and a charge amount corresponding to the number of photons received is stored in the capacitor.

In this light receiving unit, a nonlinear compression ratio of an actual physical quantity (charge amount) corresponding to the photon counting value is insufficient. It is therefore difficult to perform the photon counting in a high dynamic range under an environment of strong background light.

An objective of the present disclosure is to provide an imaging element and a distance measurement device which enable photon counting in a high dynamic range.

### Solution to the Problem

To achieve the above objective, an imaging element according to an embodiment of the present disclosure includes a plurality of pixels, each of the plurality of pixels including: a light-receiving element; a first storage element; and a charge emitter provided in each of the plurality of pixels, the charge emitter being configured to emit charges to the first storage element for a certain period of time when the light-receiving element detects light emitted from the light source and reflected by a subject over a time varying potential barrier.

### Advantages of the Invention

The present disclosure enables photon counting in a high dynamic range.

### BRIEF DESCRIPTION OF THE DRAWINGS

FIG. 1 is a block diagram illustrating a configuration of a pixel according to a first embodiment.

FIG. 2 is a diagram for illustrating an operation principle of a charge emitter according to the first embodiment.

FIG. 3 is a schematic potential diagram of the charge emitter according to the first embodiment.

FIG. 4 is a block diagram illustrating a configuration of a light-receiving sensor according to the first embodiment.

FIG. 5 is a diagram for illustrating an example circuit formed in a pixel according to the first embodiment.

FIG. 6 is a timing diagram related to a distance measurement operation of the pixel according to the first embodiment in one frame period.

FIG. 7 is a block diagram illustrating an example of a general configuration of a distance measurement device according to a second embodiment.

FIG. 8 is a diagram for illustrating a principle of distance measurement by the distance measurement device according to the second embodiment.

FIG. 9 is a diagram for illustrating a method of generating a sub-range image according to the second embodiment.

FIG. 10 is a timing diagram related to a distance measurement operation of a pixel according to the second embodiment in one frame period.

### DESCRIPTION OF EMBODIMENTS

Embodiments of the present invention will be described in detail below with reference to the drawings. The following description of advantageous embodiments is only an example in nature, and is not intended to limit the scope, applications or use of the present disclosure.

### First Embodiment

### —Configuration of Pixel—

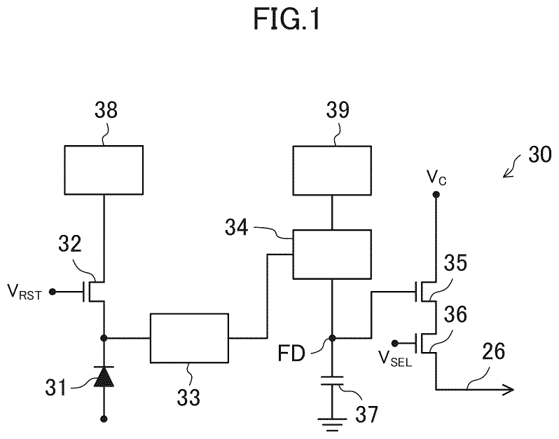

FIG. 1 is a block diagram illustrating a configuration of a pixel according to the first embodiment. The pixel 30 illustrated in FIG. 1 is disposed in the light-receiving sensor 2 (imaging element) of the distance measurement device described below.

As illustrated in FIG. 1, the pixel 30 includes a light-receiving element 31, a reset transistor 32, a photon count control circuit 33, a charge emitter 34, a source follower transistor 35, a selection transistor 36, and a first capacitor 37 (first storage element). A reset timing controller 38 and a charge supplier 39 are disposed outside the pixel 30.

The light-receiving element 31 is, for example, a photodiode (PD), such as a SPAD or an avalanche photodiode (APD).

The reset transistor 32 has: the source (or drain) to which an output terminal of the reset timing controller 38 is connected; the drain (or source) to which a cathode terminal of the light-receiving element 31 and an input terminal of the photon count control circuit 33 are connected; and the gate that receives a reset signal VRST. The reset timing controller 38 supplies a voltage to the reset transistor 32 so that the reset transistor 32 resets elements, such as the light-receiving element 31.

The photon count control circuit 33 has an output terminal to which the input terminal of the charge emitter 34 is connected. The photon count control circuit 33 performs a photon counting operation in accordance with an output from the cathode terminal of the light-receiving element 31 and outputs the result from the output terminal. For example, the photon count control circuit 33 outputs a pulse voltage to the charge emitter 34 when the light-receiving element 31 detects light (photons).

The charge emitter 34 outputs charges to a floating diffusion FD in receipt of signals from the photon count control circuit 33 and the charge supplier 39. For example, the charge emitter 34 outputs a predetermined charges to the FD when the photon count control circuit 33 outputs the pulse voltage. The charge supplier 39 supplies charges that is output to the charge emitter 34.

The source follower transistor 35 has: the source (or drain) that receives a pixel power supply bias signal Vc; the drain (or source) to which the source (or drain) of the selection transistor 36 is connected; and the gate to which the FD is connected.

The selection transistor 36 has the drain (or source) to which the output line 26 is connected, and the gate that receives the selection signal V_{SEL}.

The first capacitor 37 has one end connected to the FD and the other end connected to the ground voltage (earth). The first capacitor 37 stores the charges that has been output to the FD by the charge emitter 34.

The source follower transistor 35 outputs a pixel signal corresponding to the charge stored in the first capacitor 37 to the output line 26 when the selection transistor 36 is turned on.

Assume that in Patent Document 1, the capacitance of FD is CF, the capacitance of a storage capacitor is C_{M}, and the ratio therebetween is r_{M}=C_{M}/(C_{F}+C_{M}), and that a saturated charge amount Q₀ is transferred to the FD at the detection of each photon. In this case, the charge amount additionally stored in the storage capacitor is r_{M}ⁱ×Q₀ at the detection of the i-th photon. Therefore, the total charge amount stored in the storage capacitor when m photons are detected is expressed as follows:

$${\sum }_{i = 1}^{m} {r}_{M}^{i} {Q}_{0} = \frac{1 - {r}_{M}^{m}}{1 - {r}_{M}} \cdot {r}_{M} {Q}_{0}$$

Here, the closer the IM is to 1, the higher the photon count value can be. However, under the conditions where high resolution is practically possible with a pixel size of about 5 μm, r_{M}=0.9 is the limiting value, and the highest total count value of photons that can be stored in a pixel is only about 15.

In the present embodiment, it is preferable that a smaller amount of charge is output from the charge emitter 34 to the FD in order to obtain a high dynamic range in which the minimum count value of photons is from 1 to about 30. The minimum value of the charge amount output from the charge emitter 34 to the FD is determined by the kTC noise generated when the first capacitor 37 is charged and discharged, and a typical value is about 63 electrons at room temperature with a 15fF value of the capacitor 37. Assuming that an effective S/N ratio is 2, the charge amount necessary to output a pixel signal is about 125 electrons in the present embodiment. To control the storage of such a minute amount of charge at each photon count, the charge emitter 34 needs to have a precision circuit that allows (1) a minute current (typically 10 nA) to flow for (2) a very short period of time (typically 2 ns). However, it is extremely difficult to satisfy both (1) and (2) at the same time, considering the variation in parasitic components that occurs in the mass production process. Therefore, if a minute current is allowed to flow into the first capacitor 37, and the charge amount of a certain ratio can be stored (reduced) in the first capacitor 37 in accordance with the increment of the photon count value, the signal charge amount is compressed in a high count value region, which makes it possible to expand the dynamic range of the imaging element to a high value without changing the actual voltage value.

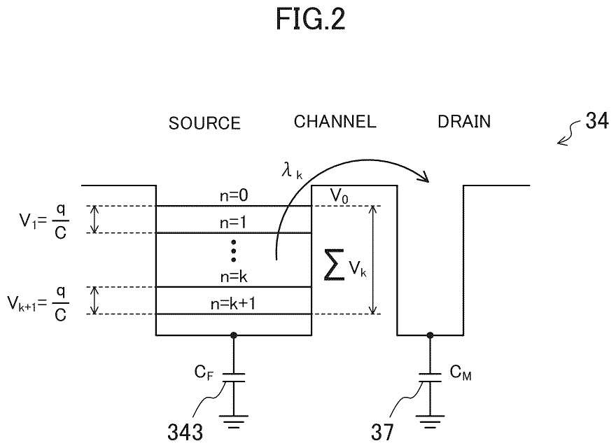

FIG. 2 is a diagram for illustrating an operation principle of the charge emitter according to the first embodiment. The charge emitter 34 is, for example, a MOSFET that has: the source (or drain) to which a capacitor (second capacitor 343 in this example) is connected; and the drain (or source) to which the first capacitor 37 is connected. By operating the MOSFET in a subthreshold region with a certain amount of charge is stored in the second capacitor 343, the charge emitter 34 outputs a minute current to the drain (first capacitor 37). For example, the charge emitter 34 emits a charge from the source to the drain for a certain period of time when a predetermined bias voltage is applied to the gate of the MOSFET each time the light-receiving element 31 detects a single photon.

FIG. 2 is a schematic potential diagram of the charge emitter 34 according to the first embodiment. In FIG. 2, n and k are parameters representing the number of electrons emitted from the second capacitor 343, which is calculated from the initial state. FIG. 2 shows the state after k electrons are emitted from the second capacitor 343, and the state of the MOSFET in which a predetermined bias voltage is applied to the gate is called Sk. The average emission rate of the charge from the second capacitor 343 when the MOSFET is in the state Sₖ is represented by λₖ. The average emission rate in the initial state So in which no charge is emitted from the second capacitor 343 is represented by 2. The source of the MOSFET is in the floating state at this moment, and if the predetermined bias voltage is applied to the channel, the voltage barrier between the source and the channel is higher by Vₖ=kq/C_{F} when the MOSFET is in the state Sₖ than when the MOSFET is in the initial state. Thus, the charge emission rate at this moment is expressed as follows, taking the Boltzmann factor into account:

$$\begin{matrix}[ Math 2 ] & \\ {λ}_{k} = {λ}_{0} \cdot exp ( - \frac{k \cdot {q}^{2}}{{k}_{B} T \cdot {C}_{F}} ) & Equation ( 1 )\end{matrix}$$

Here, assume that a predetermined bias voltage with respect to the ground is applied to the gate of the charge emitter 34 for a certain period of time ΔT each time the light-receiving element 31 detects a photon. Given that the number of charges emitted from the source to the drain of the charge emitter 34 when the first photon is detected by the light-receiving element 31 is k(1), the time needed to emit k(1) electron(s) is expressed by tk(1)=ΔT, and the following equation holds:

$$\begin{matrix}[ Math 3 ] & \\ Δ T = {t}_{k ( 1 )} = {\sum }_{i = 0}^{i = k ( 1 ) - 1} \frac{1}{{λ}_{i}} = \frac{1}{{λ}_{0}} \cdot \frac{1 - exp ( \frac{k ( t ) \cdot {q}^{2}}{{k}_{B} T \cdot {C}_{F}} )}{1 - exp ( \frac{{q}^{2}}{{k}_{B} T \cdot {C}_{F}} )} & Equation ( 2 )\end{matrix}$$

Similarly, given that the number of charges emitted when the m-th photon is detected is k(m), the following equation holds:

$$\begin{matrix}[ Math 4 ] & \\ Δ T = {t}_{k ( m )} = {\sum }_{i = k ( m - 1 )}^{i = k ( m ) - 1} \frac{1}{{λ}_{i}} = \frac{1}{{λ}_{0}} \cdot \frac{exp ( \frac{k ( m - 1 ) \cdot {q}^{2}}{{k}_{B} T \cdot {C}_{F}} ) - exp ( \frac{k ( m ) \cdot {q}^{2}}{{k}_{B} T \cdot {C}_{F}} )}{1 - exp ( \frac{{q}^{2}}{{k}_{B} T \cdot {C}_{F}} )} & Equation ( 3 )\end{matrix}$$

Therefore, the period during which the charge is emitted from the source to the drain of the charge emitter 34 while m photons are counted is expressed by m. AT, based on operation setting conditions. A total sum of tk(1) through tk(m) is obtained, and the function representing the number of charges emitted from the charge emitter 34 is given as follows:

$$\begin{matrix}[ Math 5 ] & \\ m \cdot Δ T = {\sum }_{i = 1}^{i = m} {t}_{k ( i )} = {\sum }_{i = 0}^{i = k ( m ) - 1} \frac{1}{{λ}_{i}} = \frac{1}{{λ}_{0}} \cdot \frac{1 - exp ( \frac{k ( m ) \cdot {q}^{2}}{{k}_{B} T \cdot {C}_{F}} )}{1 - exp ( \frac{{q}^{2}}{{k}_{B} T \cdot {C}_{F}} )} & Equation ( 4 )\end{matrix}$$

If Equation (4) is solved for k(m),

$$\begin{matrix}[ Math 6 ] & \\ k ( m ) = \frac{{k}_{B} T \cdot {C}_{F}}{{q}^{2}} \cdot ln ( {λ}_{0} \cdot m \cdot Δ T \cdot ( exp ( \frac{{q}^{2}}{{k}_{B} T \cdot {C}_{F}} ) - 1 ) + 1 ) & Equation ( 5 )\end{matrix}$$

Thus, the charge emission amount of the MOSFET is obtained as a function of the photon count value. As can be seen from Equation (5), the charge emission amount k(m) of the charge emitter 34 is logarithmically compressed with respect to the photon count value m. The increase in k(m) with respect to the m-value is therefore suppressed, which allows the count of higher m-values.

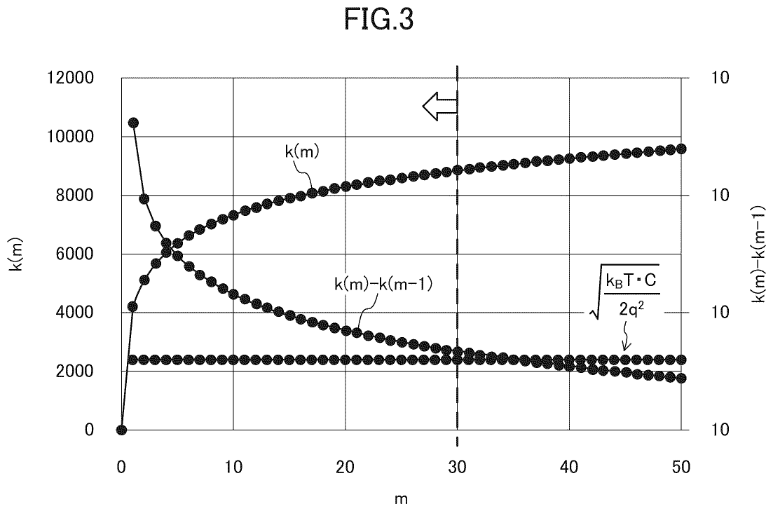

FIG. 3 shows a relationship between a photon count value and a charge emission amount of the charge emitter according to the first embodiment. FIG. 3 shows, as a function of the count value m, the charge emission amount k(m) and the charge amount k(m)−k(m−1) emitted from the charge emitter 34 within the time ΔT at each count value, in a case where the capacitance of the second capacitor 343 is C_{F}=15fF, time ΔT=10 ns, and an initial bias current is 1 μA. As mentioned above, k(m) increases logarithmically with respect to m. From the value of C_{F}=15fF, the charge amount k(m)−k(m−1) crosses the noise floor when m is 35 (m=35) or higher. In this example, it is possible to make a count up to m=30 with a certain margin, thereby realizing a dynamic range twice as high as that of known cases.

### —Configuration of Light-Receiving Sensor—

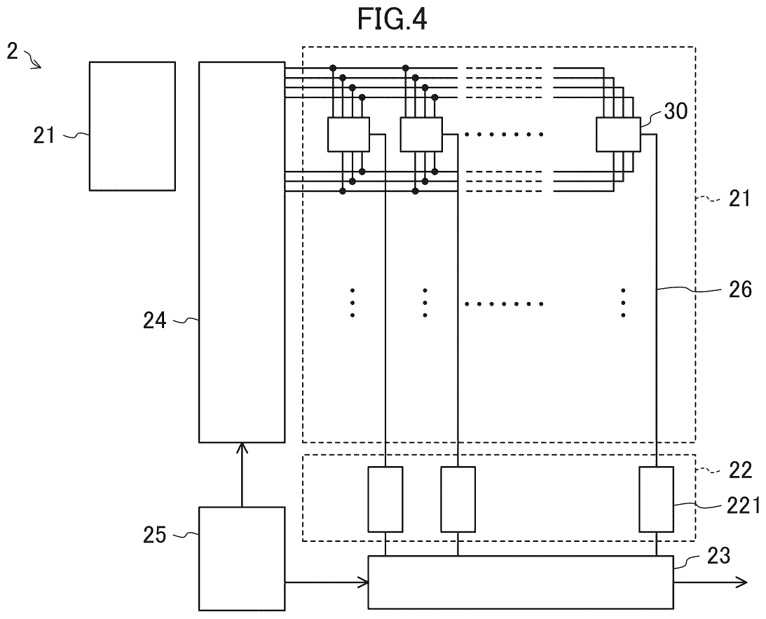

FIG. 4 is a block diagram illustrating a configuration of the light-receiving sensor according to the first embodiment. As illustrated in FIG. 4, the light-receiving sensor 2 includes a bias generator circuit 20, a pixel array 21, a readout circuit 22, a horizontal output circuit 23, a vertical drive circuit 24, and a sensor timing generator 25.

The bias generator circuit 20 supplies a bias signal (details are omitted) necessary to drive the light-receiving sensor 2. The bias signal may be supplied externally.

The pixel array 21 includes a plurality of pixels 30 arranged in an array. In the plurality of pixels 30, a selection signal V_{SEL}, a reset signal VRST, a PD bias control signal V_{D}, a charge storage signal V_{I}, a voltage charge control signal V_{R}, a pixel power supply bias signal Vc, and an inverter bias signal V_{INV} are supplied for each row. Each of the pixels 30 outputs a pixel signal indicating a detection result to the output line 26 in accordance with the selection signal V_{SEL}, the reset signal VRST, the PD bias control signal V_{D}, the charge storage signal V_{I}, the voltage charge control signal V_{R}, the pixel power supply bias signal Vc, and the inverter bias signal V_{INV} which have been supplied to the pixel 30.

The readout circuit 22 includes a plurality of column circuits 221. Each of the column circuits 221 has an amplifier and an AD converter. The column circuit 221 is provided for each column of the plurality of pixels 30. The readout circuit 22 reads out the signals output from each of the pixels 30 via the output lines 26, using the column circuit 221.

The horizontal output circuit 23 sequentially outputs, as output signals, the signals output from the readout circuit 22.

The vertical drive circuit 24 generates the selection signal V_{SEL}, the reset signal VRST, the PD bias control signal V_{D}, the charge storage signal V_{I}, the voltage charge control signal V_{R}, the pixel power supply bias signal Vc, and the inverter bias signal V_{INV} and outputs these signals to each pixel 30 at predetermined timing.

The sensor timing generator 25 outputs a drive timing signal indicating the drive timing of each of the horizontal output circuit 23 and the vertical drive circuit 24.

### —Example of Circuit Formed in Pixel—

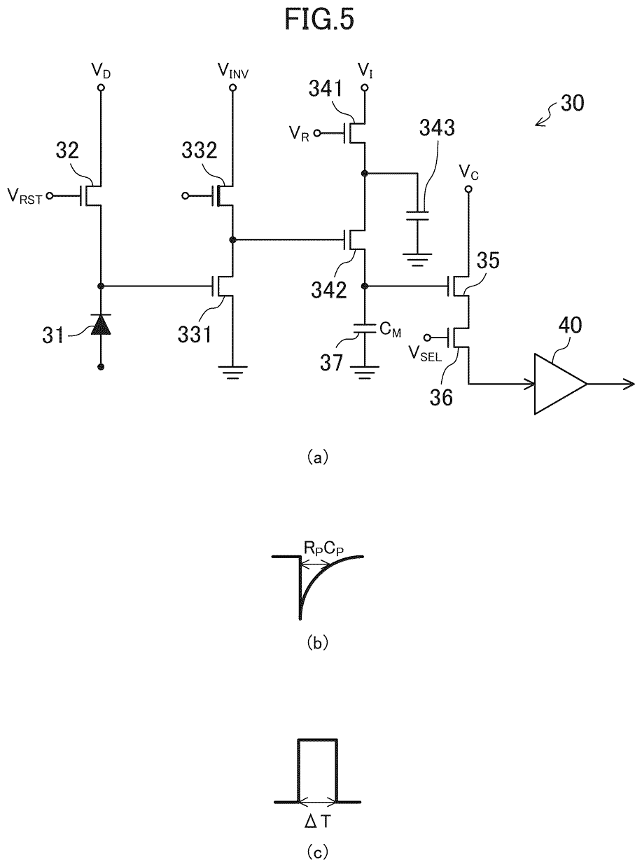

In FIG. 5, (a) is a diagram illustrating an example circuit formed in a pixel according to the first embodiment. In FIG. 5, (a) is an example of the circuit formed in the pixel in FIG. 1. As illustrated in FIG. 5, the pixel 30 includes a light-receiving element 31, a reset transistor 32, an inverting amplifier transistor 331, a load transistor 332, a transistor 341 for voltage charge, a charge emission source transistor 342, a second capacitor 343 (second storage element), a source follower transistor 35, a selection transistor 36, and a first capacitor 37. The photon count control circuit 33 in FIG. 1 includes the inverting amplifier transistor 331 and a transistor 332. The charge emitter 34 in FIG. 1 includes the transistor 341 for voltage charge, the charge emission source transistor 342, and the second capacitor 343.

The light-receiving element 31 has an anode terminal to which a predetermined voltage is applied. During an exposure period, the reset transistor 32 is turned on, and the voltage between the drain of the reset transistor 32 (PD bias control signal V_{D}) and the anode terminal of the light-receiving element 31 is kept at a predetermined breakdown voltage or higher. On the other hand, during a non-exposure period, the drain of the reset transistor 32 (PD bias control signal V_{D}) is set to 0 V to function as the source, and the voltage between the cathode terminal and the anode terminal of the light-receiving element 31 is set to an absolute voltage value lower than the breakdown voltage. Thus, no Geiger mode pulse is generated during the non-exposure period even if a photon is incident on the light-receiving element 31.

The inverting amplifier transistor 331 has: the source (or drain) connected to the drain (or source) of the load transistor 332 and the gate of the charge emission source transistor 342; the drain connected to the ground voltage (earth); and the gate connected to the drain (or source) of the reset transistor 32 and the cathode terminal of the light-receiving element 31.

The load transistor 332 has the source (or drain) that receives the inverter bias signal V_{INV}. The inverting amplifier transistor 331 serves as an inverting amplifier (inverter) using the transistor 332 as a load.

The transistor 341 for voltage charge has: the source (or drain) that receives the charge storage signal V_{I}; the gate that receives the voltage charge control signal V_{R}; the drain (or source) to which the source (or drain) of the charge emission source transistor 342 and one end of the second capacitor 343 are connected. The charge emission source transistor 342 has the drain (or source) to which the FD (not explicitly shown) and the first capacitor 37 (C_{M}) connected in parallel with the FD are connected. The second capacitor 343 has the other end to which the ground voltage is connected. The transistor 341 for voltage charge charges the second capacitor 343 so that the second capacitor 343 has a predetermined voltage in accordance with the voltage charge control signal V_{R}.

Here, when a single photon is incident on the light-receiving element 31 during the exposure period and a Geiger mode pulse is generated by avalanche multiplication, the voltage at the cathode terminal of the light-receiving element 31 drops instantly. The voltage at the cathode terminal of the light-receiving element 31 automatically returns to the voltage supplied from the source of the reset transistor 32 (PD bias control signal V_{D}) after a lapse of a time constant R_{P}·Cₛ(Cₛ is the capacitance of the light-receiving element 31 and wiring, and R_{P} is the total resistance (equivalent to quenching resistance) of the channel of the reset transistor 32 and wiring) (see (b) in FIG. 5). That is, the light-receiving element 31 performs a self-quenching and self-recovery operation. The voltage at the cathode terminal of the light-receiving element 31 is input to the inverter (the photon count control circuit 33: the inverting amplifier transistor 331 and the transistor 332), causing the inverter to generate a rectangular wave signal having a width of a certain period of time ΔT that is determined by a threshold value of the inverter (see (c) in FIG. 5). Specifically, the voltage at the cathode terminal of the light-receiving element 31 is input to the gate of the inverting amplifier transistor 331, and the rectangular wave signal is output to the gate of the charge emission source transistor 342. That is, the certain period of time ΔT is determined as follows by using a as a parameter:

$$\begin{matrix}[ Math 7 ] & \\ Δ T = a \cdot {R}_{P} \cdot {C}_{S} & Equation ( 6 )\end{matrix}$$

That is, a circuit that generates a rectangular wave signal which becomes high in voltage only for the certain period of time ΔT due to the capacitance Cₛ, the resistance R_{P}, and the inverter is formed in the pixel 30. This rectangular wave signal is input to the gate of the charge emission source transistor 342, turning the charge emission source transistor 342 on only for the certain period of time ΔT. In other words, when the light-receiving element 31 receives a photon, the charge emission source transistor 342 emits electrons from the second capacitor 343 charged to have a predetermined voltage, to the first capacitor 37 during the certain period of time ΔT.

Here, it is possible to set the charge emission rate of the charge emission source transistor 342 to the state represented by Equation (1) by setting a voltage to be charged in the second capacitor 343 to be equal to or lower than the subthreshold voltage of the charge emission source transistor 342. Accordingly, in the pixel 30, it is possible to obtain the charge storage amount k(m) in accordance with Equation (5) with respect to the photon count m, making it possible to obtain a high photon count value up to about 30. A voltage corresponding to this charge storage amount is read out from the pixel 30 by the source follower transistor 35 and the selection transistor 36 and is amplified and output by a column amplifier circuit 40 (antilogarithm converter circuit). The column amplifier circuit 40 includes an antilogarithm converter circuit and outputs a voltage corresponding to the charge amount expressed by Equation (5) as a linear function with respect to the photon count m.

### —Operation of Pixel—

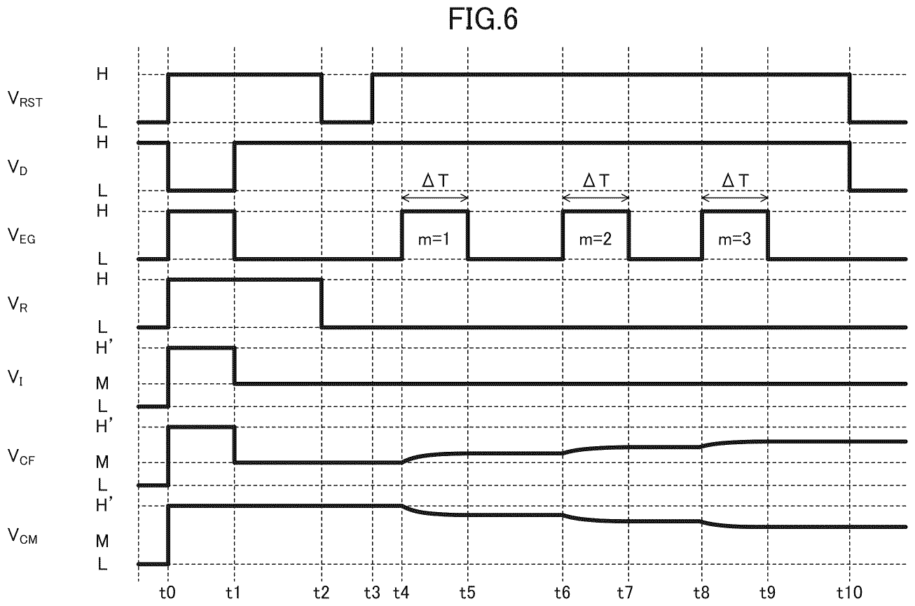

FIG. 6 is a timing diagram related to a distance measurement operation of a pixel according to the first embodiment in one frame period. FIG. 6 shows, from the top to the bottom, the reset signal VRST, the PD bias control signal V_{D}, a gate voltage V_{EG} of the charge emission source transistor 342, the voltage charge control signal V_{R}, the charge storage signal V_{I}, a voltage V_{CF} charged in the second capacitor 343, and a voltage V_{CM} charged in the first capacitor which is the same level as the gate voltage of source follower transistor 35. The driving signal for the light source 1 is generated by the vertical drive circuit 24 which has received a signal from the timing signal generator 4. The light-receiving element 31 is biased in a Geiger mode during exposure, in which the PD bias control signal V_{D} received in the source of the reset transistor 32 is input to the cathode terminal, and the voltage produced by the difference from a predetermined voltage input to the anode terminal exceeds the breakdown voltage by about 1 V.

At the initial time t0, the reset signal VRST becomes high level (H), and the reset transistor 32 is thus turned on. The PD bias control signal V_{D} becomes low level (L), which makes the voltage at the cathode terminal of the light-receiving element 31 and the gate voltage of the inverting amplifier transistor 331 low level. At this moment, the inverting amplifier transistor 331 (inverter) outputs the high-level voltage to the gate of the charge emission source transistor 342. The charge emission source transistor 342 is turned on as a result. The voltage charge control signal V_{R} and the charge storage signal V_{I} also become high level. As a result, the transistor 341 for voltage charge is turned on, and the first capacitor 37 and the second capacitor 343 are charged to high level (H′). At this time, the first capacitor 37 and the second capacitor 343 are charged to a voltage about 0.5 V to 1.0 V higher than the middle level of the charge storage signal V_{I}, which is set after time t1.

At time t1, the PD bias control signal V_{D} becomes high level, which makes the voltage at the cathode terminal of the light-receiving element 31 and the gate voltage of the inverting amplifier transistor 331 high level. This allows the light-receiving element 31 to receive light. At this moment, the inverting amplifier transistor 331 (inverter) outputs the low-level voltage to the gate of the charge emission source transistor 342, turning the charge emission source transistor 342 off. Accordingly, the first capacitor 37 maintains a high-level voltage until the light-receiving element 31 detects a photon. The charge storage signal V_{I} becomes middle level (M), which is an intermediate voltage, and the second capacitor 343 is charged to the middle level.

At time t2, the reset signal VRST and the charge storage signal V_{I} become low level, and the initialization of the light-receiving element 31, the first capacitor 37, and the second capacitor 343 is completed.

At time t3, the reset signal VRST becomes high level, and the reset transistor 32 is thus turned on. A high-level voltage is therefore applied to the cathode terminal of the light-receiving element 31, resulting in a state in which a voltage higher than the break voltage is applied between the cathode terminal and the anode terminal of the light-receiving element 31. The exposure starts accordingly.

In the present embodiment, the exposure period is from time t3 to time t10. In FIG. 6, the light-receiving element 31 detects a single photon immediately before times t4, t6, and t8. At times t4, t6, and t8, the light-receiving element 31 generates a Geiger mode pulse after receiving a single photon. The light-receiving element 31 further performs a self-quenching and self-recovery operation, thereby outputting the rectangular wave signal of (b) in FIG. 5. The inverting amplifier transistor 331 (inverter) outputs a rectangular pulse ((c) in FIG. 5) of the certain period of time ΔT, according to Equation (6). As a result, the gate voltage V_{EG} becomes high level only for the certain period of time ΔT, and the charge emission source transistor 342 is turned on only for the certain period of time ΔT. Accordingly, the charge emission source transistor 342 emits electrons from the second capacitor 343 to the first capacitor 37 in each of the periods t4 to t5, t6 to t7, and t8 to t9, according to Equation (5). The voltage V_{CF} charged in the second capacitor 343 therefore gradually increases, and the voltage V_{CM} charged in the first capacitor gradually decreases. The change in voltage in each of the periods t4 to t5, t6 to t7, and t8 to t9 changes logarithmically (nonlinearly) with respect to the number of photons as shown in Equation (5).

At time t10, the reset signal VRST and the PD bias control signal V_{D} become low level, and the exposure period ends. Then, the process shifts to the readout period. After readouts from all the pixels end, the process shifts to the next frame.

### Second Embodiment

### —General Configuration of Distance Measurement Device—

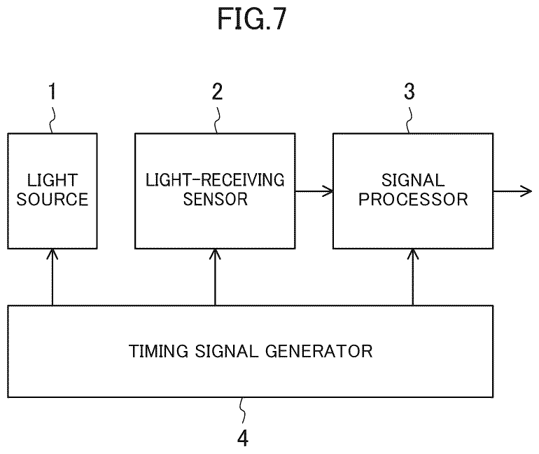

FIG. 7 is a block diagram illustrating an example of a general configuration of a distance measurement device according to a second embodiment. As illustrated in FIG. 7, the distance measurement device according to the present embodiment includes a light source 1, a light-receiving sensor 2, a signal processor 3, and a timing signal generator 4. The imaging element (light-receiving sensor 2) of the first embodiment is used as the light-receiving sensor 2.

The light-receiving sensor 2 receives light emitted by the light source 1 and reflected off a subject. The light-receiving sensor 2 outputs an output signal indicating the result of light receiving to the signal processor 3.

The signal processor 3 calculates the distance to the subject based on the signal received from the light-receiving sensor 2. The signal processor 3 outputs a signal indicating the calculation result.

The timing signal generator 4 outputs signals indicating respective drive timings to the light source 1, the light-receiving sensor 2, and the signal processor 3. Specifically, the timing signal generator 4 outputs a signal synchronized in phase with the frame rate of the light-receiving sensor 2 so that the light source 1, the light-receiving sensor 2, and the signal processor 3 operate in a manner in which all pixels are exposed simultaneously (global shutter). The frequencies of the signals output by the timing signal generator 4 may differ from each other.

### —Sub-Range Image—

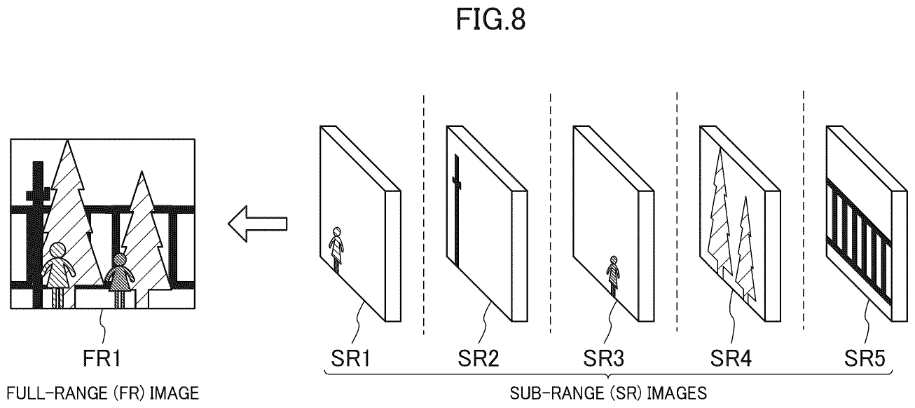

FIG. 8 is a diagram for illustrating a principle of distance measurement by the distance measurement device according to the second embodiment. The distance measurement device according to the second embodiment can generate sub-range (SR) images SR1 to SR5 and a full-range (FR) image FR1 including the sub-range images SR1 to SR5. In the following description, the same reference characters as those in the above embodiment may be used to represent equivalent configurations, and the detailed explanation thereof may be omitted. For example, the flight time (the time from when light is emitted from the light source 1 to when the light reflected by the subject returns to the light-receiving sensor 2) varies depending on the distance from the light source 1 to the subject. A subject at a predetermined distance can be detected by setting the exposure time in the light-receiving sensor 2 based on the flight time.

In the second embodiment, the exposure time for each sub-range is set to a timing delayed, from when the light source emits light, by a round-trip flight time of the distance corresponding to the center position between previous and following sub-ranges (for example, the sub-range images SR2 and SR4 in the case of the sub-range image SR3). The exposure based on the exposure time is repeated (i.e., the returning light (photons) are counted), which makes it possible to obtain the photon count value at a position corresponding to each sub-range. When the total count value exceeds a certain threshold value, the light-receiving sensor 2 outputs a signal of a predetermined output level, considering that there is a subject, and generates an image of that sub-range. The light-receiving sensor 2 generates a full-range image FR1 by superimposing a plurality of sub-range images obtained (sub-range images SR1 to SR5 in FIG. 8).

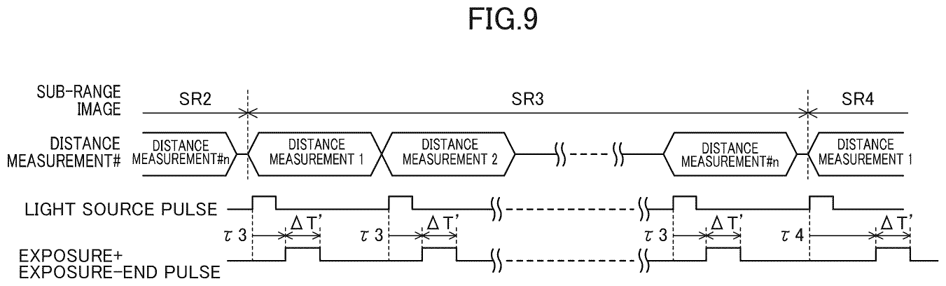

FIG. 9 is a diagram for illustrating a method of generating a sub-range image according to the second embodiment. FIG. 9 shows a generation timing of the sub-range image SR3.

As illustrated in FIG. 9, in the second embodiment, an exposure+exposure end pulse (a pulse whose rising corresponds to the start of exposure and whose falling corresponds to the end of the exposure) is generated at a timing delayed by time τ3 (distance measurement period), which is a time equivalent to the flight time corresponding to the sub-range image SR3, from when light (pulse) is emitted from the light source 1. In other words, the light-receiving sensor 2 causes the exposure in the period when the exposure+exposure-end pulse is high to generate the sub-range image SR3. The light-receiving sensor 2 performs this exposure operation multiple times (n times in this example) to create the sub-range image SR3 and counts the number of photons reflected back from the subject.

In a distance measurement for cases in which the distance to the subject is short, such as the sub-range images SR1, SR2, and SR3, a larger number of photons (typically 20 or more) must be counted because a large amount of light is reflected from the subject. On the other hand, in a distance measurement for cases in which the distance to the subject is long, such as the sub-range images SR4 and SR5, the number of photons necessary for counting is small (typically 2 or less) because a small amount of light is reflected from the subject. In known technology, it is difficult to perform distance measurement imaging of the photon count value for which a wide dynamic range that differs depending on the measurement distance range is required, in the same frame using the same pixel circuit.

### —Operation of Pixel—

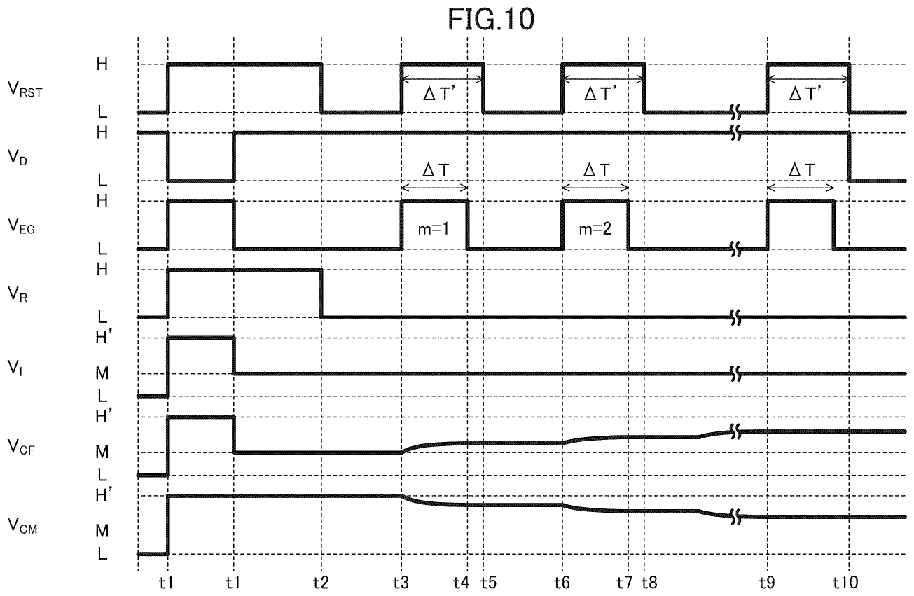

FIG. 10 is a timing diagram related to a distance measurement operation of a pixel according to the second embodiment in one frame period. The imaging element (light-receiving sensor 2) of FIG. 5 and the pixel 30 of (a) in FIG. 4 are used in the second embodiment. In the second embodiment, the timing signal generator 4 inputs, to the sensor timing generator 25, a light emission signal indicating light emission timing of the light source 1. The sensor timing generator 25 outputs signals in response to the light emission signal. In the present embodiment, in a case of distance measurement of a short distance (for example, the sub-range images SR1, SR2, and SR3), the operation (time decrease current source mode) illustrated in FIG. 10 is performed to count a larger number of photons because a great amount of light is reflected from the subject.

The operation is the same as the operation in FIG. 6 from time t0 to time t2.

After the timing signal generator 4 outputs the light emission signal (not shown in FIG. 10), the exposure starts after a delay time (13 in the sub-range image SR3) corresponding to the flight distance to the center of each sub-range. In FIG. 10, the exposure starts at times t3, t6, and t9 and ends at times t5, t8, and t10. The exposure cycle is the same as the light emission cycle of the light source 1. In this case, the exposure-end timing is set so that the exposure period time ΔT′ that is longer than the charge emission time ΔT determined by Expression (6). In other words, the exposure time of the charge emission source transistor 342 is set in consideration of the quenching time for a case where a photon is detected in the latter half of the exposure period.

On the other hand, in a case of distance measurement of a long distance (for example, the sub-range images SR4 and SR5), the operation illustrated in FIG. 10 is not necessary because only a small amount of light is reflected from the subject. Specifically, the charge emission source transistor 342 operates in a constant current mode by applying a fixed bias voltage to the source all the time. Thus, a smaller number of photons can be counted while maintaining the linearity of the charges stored on capacitor 37.

As explained above, the distance measurement device of the second embodiment can switch the charge emission source transistor 342 between the time decrease current source mode and the constant current source mode according to the number of photons to be detected which differs from short to long distances. This configuration achieves the high-precision distance measurement by photon counting in a high dynamic range.

In the foregoing description, the embodiments serve as examples of the technique disclosed in the present application. However, the technique in the present disclosure is not limited to the embodiments, and is also applicable to embodiments where modifications, substitutions, additions, or omissions are made appropriately.

### DESCRIPTION OF REFERENCE CHARACTERS

1 Light Source
2 Light-Receiving Sensor (Imaging Element)
4 Timing Generator
26 Output Line
30 Pixel
31 Light-Receiving Element
34 Charge Emitter
37 First Capacitor (First Storage Element)
343 Second Capacitor (Second Storage Element)
40 Column Amplifier Circuit (Antilogarithm Converter Circuit)

1. An imaging element comprising:
a light source; and
a plurality of pixels, each of the plurality of pixels including:
a light-receiving element;
a first storage element; and
a charge emitter provided in each of the plurality of pixels, the charge emitter being configured to emit a charge to the first storage element for a certain period of time when the light-receiving element detects light emitted from the light source and reflected by a subject.

2. The imaging element of claim 1, wherein
the certain period of time is a time from when the light-receiving element detects light to self-quenching.

3. The imaging element of claim 1, wherein
the charge emitter
includes a second storage element,
emits the charge from the second storage element to the first storage element for the certain period of time when the light-receiving element detects light, and
prior to emitting the charge, stores the charge of a predetermined amount in the second storage element.

4. The imaging element of claim 1, wherein
an antilogarithm converter circuit configured to convert a pixel signal to an antilogarithm is connected to an output line of the plurality of pixels.

5. The imaging element of claim 1, wherein
the charge emitter operates in a time decrease current source mode or a constant current mode according to a number of photons detected by the light-receiving element, in the time decrease current source mode, the charge being emitted to the first storage element for the certain period of time, in the constant current mode, a constant current is output to the first storage element.

6. The imaging element of claim 1, wherein
the light-receiving element is an avalanche photodiode.

7. A distance measurement device comprising:
the imaging element of claim 1;
a timing signal generator configured to output, to the plurality of pixels, an exposure start signal indicating a timing of start of exposure; and
a signal processor configured to calculate a distance to a subject, from a pixel signal output from each of the plurality of pixels.
